(19) United States
(12) Patent Application Publication
(10) Pub. No.: US 2002/0141056 A1
(43) Pub. Date: Oct. 3, 2002

(54) Stereoscopic video display device and dot-shaped light emission member and dot-shaped light transmission member

(75) Inventors: Tetsuro Kobayashi, Hyogo (JP); Ken Mashitani, Osaka (JP); Masutaka Inoue, Osaka (JP); Goro Hamagishi, Osaka (JP); Shun-ichi Kishimoto, Osaka (JP); Masahiro Higashino, Osaka (JP)

Correspondence Address: ARMSTRONG,WESTERMAN & HATTORI, LLP, 1725 K STREET, NW., SUITE 1000, WASHINGTON, DC, 20006, US

(73) Assignee: Osaka University, Suita-shi (JP)

(21) Appl. No.: 10/105,358

(22) Filed: Mar. 26, 2002

(30) Foreign Application Priority Data
Mar. 28, 2001 (JP) 2001-093140

(51) Int. Cl. G02B 27/22

(52) U.S. Cl. 359/462; 359/466

(57) ABSTRACT

A stereoscopic video display device comprises three video generators for respectively feeding red, green, and blue images, and a light beam synthesis system. Each of the video generators comprises a backlight, a liquid crystal display panel comprising a color transmission film for each of the colors, and a liquid crystal panel driver. The backlight comprises a light source and a pinhole array plate. A group of light beams is given to the liquid crystal display panel from each of pinholes in the pinhole array plate. A liquid crystal display panel driver feeds a pixel driving signal to the liquid crystal display panel, to form a pixel area, composed of a plurality of pixels, corresponding to each of the pinholes. Each of the pixels composing the pixel area controls the amount of light transmission of the light beam in each direction from the corresponding pinhole. Consequently, the intensity of the light beam in each of the directions is reproduced. The light beam synthesis system synthesizes the groups of light beams in the respective colors from the video generators and introduces the synthesized groups of light beams into a viewer.

### BACKGROUND OF THE INVENTION

1. Field of the Invention

The present invention relates to a stereoscopic video display device using a so-called light beam reproduction system.

As methods of realizing stereoscopic video display without requiring special glasses, a parallax barrier system, a lenticular lens system, and so forth have been conventionally known. In the systems, right eye images and left eye images which have binocular parallax are alternately displayed on a display screen in a strip shape. Accordingly, a stereoscopic effect in the horizontal direction is obtained. However, a stereoscopic effect in the vertical direction cannot be obtained, with which a viewer is unsatisfied. Further, outside the proper viewing position, there occurs such a phenomenon called reversed view that left eye video is incident on the right eye, while right eye video is incident on the left eye, for example Accordingly, the viewing position cannot be freely selected, which is inconvenient.

On the other hand, in recent years, a stereoscopic video display method called a light beam reproduction system capable of freely selecting the viewing position has been proposed. The light beam reproduction system is a system for recording and reproducing on a plane information representing light beams passing through the plane (i.e., the direction of the light beams and the spread of the light beams corresponding to light scattered from an object). A reproducing apparatus therefor can be constituted by a backlight 51, a pinhole array plate 52, and a liquid crystal display panel 53, as shown in FIG. 8A, for example.

It can be seen that light beams are emitted in several directions in a predetermined range from each of pinholes 52a in the pinhole array plate 52. A pixel area 53a corresponding to each of the pinholes 52a is formed in the liquid crystal display panel 53. The pixel area 53a is composed of 9 to 20 pixels in width and 3 to 20 pixels in length, for example. Each of the pixels composing the pixel area 53a controls the amount of light transmission of the light beam in each of the directions from the corresponding pinhole 52a. Consequently, the intensity of the light beam in each of the directions is reproduced.

More specifically, an amount of light transmission is reproduced at each of pixels in correspondence with a predetermined point of the object A. For example, an amount of light transmission which represents a portion A1 of the object A is set at a pixel a1 in a pixel area 53a1 which will receive a light beam from a pinhole 52a1, an amount of light transmission which represents a portion A2 of the object A is set at a pixel a2 in a pixel area 53a2 which will receive a light beam from a pinhole 52a2, an amount of light transmission which represents a portion A3 of the object A is set at a pixel a3 in a pixel area 53a3 which will receive a light beam from a pinhole 52a3, as shown in FIG. 8B. Consequently, a viewer Z recognizes the object A in a stereoscopic manner.

In such a stereoscopic video display device using a light beam reproduction system, the larger the number of light beams to be reproduced is, the better the quality of images to be obtained can be. On the other hand, in order to increase the number of light beams to be reproduced, a pixel area corresponding to each of the pinholes 52a must be composed of more pixels. There is a limit to the increase in the number of pixels composing the liquid crystal display panel 53.

### SUMMARY OF THE INVENTION

In view of the foregoing circumstances, an object of the present invention is to provide a stereoscopic video display device capable of obtaining images of good quality by substantially increasing the number of light beams to be reproduced.

In order to solve the above-mentioned problem, a stereoscopic video display device according to the present invention is characterized by comprising a backlight for red, a backlight for green, and a backlight for blue which are provided as a backlight constructed by arranging dot-shaped light emitters each giving a group of light beams corresponding to light scattered from an object in a plane shape with predetermined spacing; a light bulb for red, a light bulb for green, and a light bulb for blue which are respectively arranged on the side of light emission of the backlights; a red light bulb driver, a green light bulb driver, and a blue light bulb driver which are provided as a light bulb driver for setting an image to be displayed in pixel areas, of the light bulb, corresponding to the light emitters of the backlight; and a light beam synthesis system for synthesizing the group of light beams which has passed through the light bulb for red, the group of light beams which has passed through the light bulb for green, and the group of light beams which has passed through the light bulb for blue and emitting the synthesized groups of light beams.

A stereoscopic video display device according to the present invention is characterized by comprising a display for red, a display for green, and a display for blue; dot-shaped light transmission area forming panels, each having dot-shaped light transmitters on which video light from the corresponding display is incident in a plane shape with predetermined spacing and giving a group of light beams corresponding to light scattered from an object, which are respectively arranged on the side of video light emission of the displays; a red display driver, a green display driver, and a blue display driver which are provided as a display driver for setting an image to be displayed in pixel areas, of the display, corresponding to the light transmitters; and a light beam synthesis system for synthesizing the group of light beams from the display for red, the group of light beams from the display for green, and the group of light beams from the display for blue and emitting the synthesized groups of light beams.

In these configurations, out of the amounts of light transmission which will respectively represent certain portions of the object, a red light component is set by the light bulb for red or the display for red, a green light component is set by the light bulb for green or the display for green, and a blue light component is set by the light bulb for blue or the display for blue. The groups of light beams in the respective colors are synthesized by the light beam synthesis system, and are introduced into a viewer. Consequently, more highly precise images can be reproduced, as compared with those in a case where only one color display in which pixels for red, pixels for green, and pixels for blue are provided on a single substrate is used.

In the above-mentioned configurations, the positions of the corresponding light emitters or the corresponding light transmitters in red, green, and blue may be overlapped with one another in a video synthesized state. Further, a dichroic mirror can be used as the light beam synthesis system.

A stereoscopic video display device according to the present invention is characterized by comprising a plurality of white backlights each constructed by arranging dot-shaped light emitters each giving a group of light beams corresponding to light scattered from an object in a plane shape with predetermined spacing; color light bulbs which are respectively arranged on the side of light emission of the white backlights; light bulb drivers each setting a color image to be displayed in pixel areas, of the color light bulb, corresponding to the light emitters of the white backlight; and a light beam synthesis system for synthesizing the groups of light beams which have respectively passed through the color light bulbs and emitting the synthesized groups of light beams, the positions of the corresponding light emitters of the white backlights in a synthesized state by the light beam synthesis system being shifted from one another.

A stereoscopic video display device according to the present invention is characterized by comprising a plurality of color displays each displaying an image; dot-shaped light transmission area forming panels each having dot-shaped light transmitters on which video light from the corresponding color display is incident in a plane shape with predetermined spacing and provided on the side of video light emission of the color display in order to give a group of light beams corresponding to light scattered from an object; display drivers each setting an image to be displayed in pixel areas, of the color display, corresponding to the light transmitters; and a light beam synthesis system for synthesizing the groups of light beams which have passed through the respective color displays and emitting the synthesized groups of light beams, the positions of the corresponding light transmitters of the dot-shaped light transmission area forming panels in a synthesized state by the light beam synthesis system being shifted from one another.

In these configurations, the groups of light beams respectively set by the plurality of color light bulbs or color displays are synthesized by the light beam synthesis system. Accordingly, substantial resolution is improved (the number of light beams for reproducing the object is increased), thereby obtaining images of good quality.

In the above-mentioned configurations, although the color display images respectively displayed in the color light bulbs or the color displays may be the same, the color display images respectively displayed in the color light bulbs or the color displays may differ in correspondence with the shifts among the positions of the light emitters or the light transmitters. Further, a half mirror can be used as the light beam synthesis system.

In a dot-shaped light emission member having dot-shaped light emitters arranged therein in a plane shape with predetermined spacing and giving a group of light beams corresponding to light scattered from an object to pixels composing a light bulb having a lattice-shaped black portion by the dot-shaped light emitters, a dot-shaped light emission member according to the present invention (hereinafter referred to as a first dot-shaped light emission member in this item) is characterized in that the dot-shaped light emitter forms a square shape, and the width and the height thereof are set to approximately integral multiples of a horizontal pitch and a vertical pitch of the pixels.

In a dot-shaped light transmission member having dot-shaped light transmitters arranged therein in a plane shape with predetermined spacing and giving a group of light beams corresponding to light scattered from an object to light beams respectively emitted from pixels composing a display having a lattice-shaped black portion by the dot-shaped light transmitters, a dot-shaped light transmission member according to the present invention (hereinafter referred to as a first dot-shaped light transmission member in this item) is characterized in that the dot-shaped light transmitter forms a square shape, and the width and the height thereof are set to approximately integral multiples of a horizontal pitch and a vertical pitch of the pixels.

In these configurations, the total area of the visible pixels is hardly changed even if the head of the viewer is moved, thereby making it possible to reduce moiré. The first dot-shaped light emission member or the first dot-shaped light transmission member can be used for the stereoscopic video display device having the light beam synthesis system for synthesizing the light beams from the light bulb or the display having the lattice-shaped black portion. Further, it can be used for a stereoscopic video display device using a light bulb or a display having a lattice-shaped black portion even if it does not have such a light beam synthesis system.

In a dot-shaped light emission member having dot-shaped light emitters arranged therein in a plane shape with predetermined spacing and giving a group of light beams corresponding to light scattered from an object to pixels composing each of pixel areas of a color light bulb by the dot-shaped light emitters, a dot-shaped light emission member according to the present invention (hereinafter referred to as a second dot-shaped light emission member in this item) is characterized in that the size of the dot-shaped light emitter is set to a size including all the pixels in the three primary colors in the color light bulb at an equal ratio.

In a dot-shaped light transmission member having dot-shaped light transmitters arranged therein in a plane shape with predetermined spacing and giving a group of light beams corresponding to light scattered from an object to light beams respectively emitted from pixels composing each of pixel areas of a color display by the dot-shaped light transmitters, a dot-shaped light transmission member according to the present invention (hereinafter referred to as a second dot-shaped light transmission member in this item) is characterized in that the size of the dot-shaped light transmitter is set to a size including all the pixels in the three primary colors in the color display at an equal ratio.

In these configurations, the ratio of red, green, and blue of the visible pixels is hardly changed even if the head of the viewer is moved, thereby making it possible to perform good white display. The second dot-shaped light emission member or the second dot-shaped light transmission member can be used for the stereoscopic video display device having the light beam synthesis system for synthesizing the light beams from the color light bulb or the color display. Further, it can be used for a stereoscopic video display device using a color light bulb or a color display even if it does not have such a light beam synthesis system.

In a dot-shaped light emission member having dot-shaped light emitters arranged therein in a plane shape with predetermined spacing and giving a group of light beams corresponding to light scattered from an object to pixels composing each of pixel areas of a color light bulb by the dot-shaped light emitters, a dot-shaped light emission member according to the present invention (hereinafter referred to as a third dot-shaped light emission member in this item) is characterized in that the number of pixels in at least one of the lateral direction and the longitudinal direction in the pixel area is a number other than multiples of three and the size of the dot-shaped light emitter is set to a size including the pixels in one or two of the three primary colors in the color light bulb or a size including the pixels in the one or two colors extra in addition to the pixels in the three primary colors.

In a dot-shaped light transmission member having dot-shaped light transmitters arranged therein in a plane shape with predetermined spacing and giving a group of light beams corresponding to light scattered from an object to light beams respectively emitted from pixels composing each of pixel areas of a color display by the dot-shaped light transmitters, a dot-shaped light transmission member according to the present invention (hereinafter referred to as a third dot-shaped light transmission member in this item) is characterized in that the number of pixels in at least one of the lateral direction and the longitudinal direction in the pixel area is a number other than multiples of three, and the size of the dot-shaped light transmitter is set to a size including the pixels in one or two of the three primary colors in the color display or a size including the pixels in the one or two colors extra in addition to the pixels in the three primary colors.

In these configurations, the number of pixels in at least one of the lateral direction and the longitudinal direction is set to a number other than multiples of three. Accordingly, the three pixels which correspond to one another in the adjacent three pixel areas are a red pixel, a green pixel, and a blue pixel. That is, white display is ensured at the three pixels which correspond to one another in the adjacent three pixel areas, and the ratio of red, green, and blue of the pixels which the viewer can see is hardly changed, thereby making it possible to perform good white display. The third dot-shaped light emission member or the third dot-shaped light transmission member can be used for the stereoscopic video display device having the light beam synthesis system for synthesizing the light beams from the color light bulb or the color display. Further, it can be used for a stereoscopic video display device using a color light bulb or a color display even if it does not have such a light beam synthesis system.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view showing a stereoscopic video display device according to a first embodiment;

FIG. 2A is a diagram showing the configuration of a red video generator shown in FIG. 1, and FIG. 2B is a diagram for explaining a state where light beams are synthesized;

FIG. 3 is a diagram showing a pinhole array plate suitable for use in a video display panel having a lattice-shaped black portion, where FIG. 3A is an oblique view, and FIG. 3B is a front view;

FIG. 4 is a cross-sectional view showing a stereoscopic video display device according to a second embodiment;

FIG. 5A is a diagram showing the configuration of a video generator, and FIG. 5B is a diagram for explaining the function of a state where light beams are synthesized;

FIG. 6 is an oblique view showing the positional relationship among pinholes, for example, in a video synthesized state in the stereoscopic video display device shown in FIG. 4;

FIG. 7 is a diagram showing a pinhole array plate suitable in a configuration using a color video display panel, where

FIG. 7A is an oblique view showing the relationship between pinholes in the pinhole array plate and pixels, and

FIG. 7B is a front view thereof, and a

FIG. 7C is a front view showing another example of the pinhole array plate; and

FIG. 8A is a diagram showing a conventional stereoscopic video display device, and

FIG. 8B is a diagram for explaining the function thereof.

### DESCRIPTION OF THE PREFERRED EMBODIMENTS

(Embodiment 1)

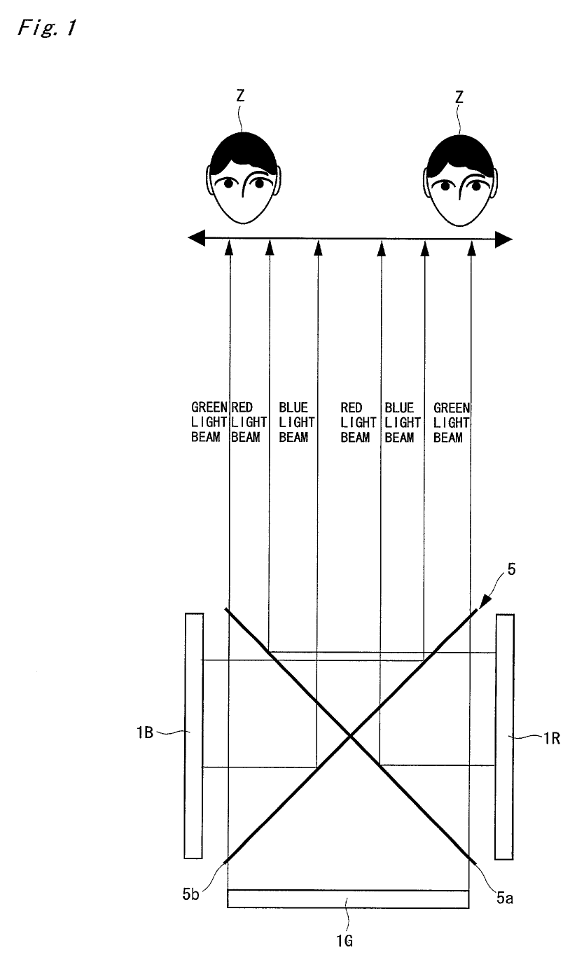

A stereoscopic video display device according to a first embodiment of the present invention will be described on the basis of FIGS. 1 to 3.

Fig . 1 is a plane view showing the stereoscopic video display device according to the present embodiment. The stereoscopic video display device comprises a red video generator 1R, a green video generator 1G , a blue video generator 1B , and a light beam synthesis system 5. The red video generator 1R and the blue video generator 1B are arranged opposite to each other, and the light beam synthesis system 5 is arranged therebetween. The green video generator 1G is arranged on the side of light emission of the light beam synthesis system 5 (on the far side as viewed from a viewer Z) at a corresponding position between the red video generator 1R and the blue video generator 1B.

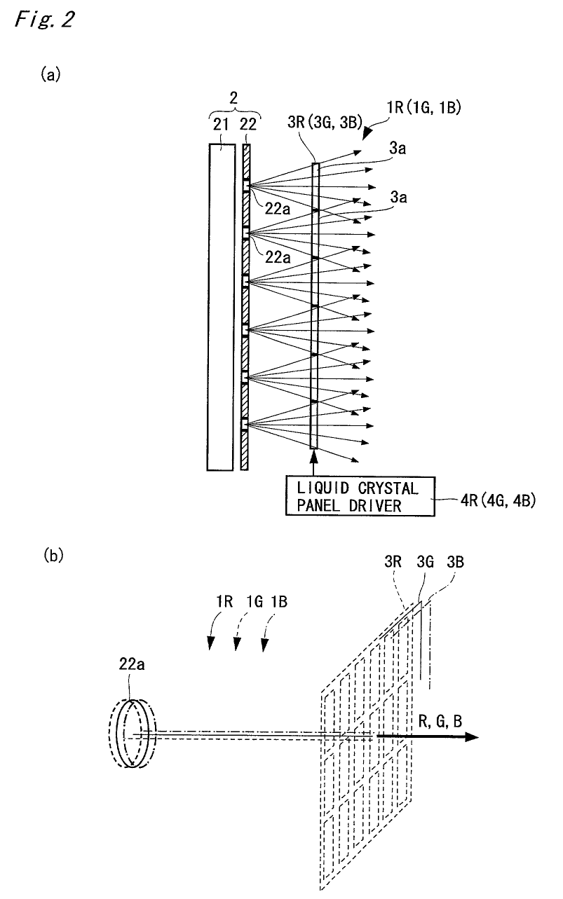

The video generators 1R, 1G, and 1B have the same configuration. In FIG. 2A, the red video generator 1R is illustrated, and its constituent elements are assigned reference characters 3R and 4R. In order to indicate constituent elements of the video generator in the other color which correspond to the constituent elements of the red video generator 1R, however, reference characters 3G and 3B or 4G and 4B are also assigned thereto.

The red video generator 1R comprises a backlight 2, a liquid crystal display panel for red 3R provided on the side of light emission of the backlight 2, and a liquid crystal panel driver 4R for driving the liquid crystal display panel 3R.

The backlight 2 comprises a plate-shaped light source 21 for emitting white light, for example, and a pinhole array plate 22. The pinhole array plate 22 has a plurality of round pinholes 22a formed therein with predetermined spacing. A group of light beams is given to the liquid crystal display panel 3R from each of the pinholes 22a.

The liquid crystal display panel 3R has a red transmission film. Further, the liquid crystal display panel driver 4R feeds a pixel driving signal to the liquid crystal display panel 3R, to form pixel areas 3a each composed of a plurality of pixels, respectively corresponding to the pinholes 22a. The pixel area 3a is composed of 6 to 20 pixels in width and 3 to 20 pixels in length, for example. The pixels composing the pixel area 3a respectively control the amounts of light transmission of red light beams in each direction from the corresponding pinhole 22a. Consequently, the intensity of the red light beam in each of the directions is reproduced.

In the green video generator 1G, the liquid crystal display panel 3G has a green transmission film, and the liquid crystal display panel driver 4G feeds a pixel driving signal for green pixels to the liquid crystal display panel 3G. Further, in the blue video generator 1B, the liquid crystal display panel 3B has a blue transmission film, and the liquid crystal display panel driver 4B feeds a pixel driving signal for blue pixels to the liquid crystal display panel 3B.

The driving signals respectively fed to the liquid crystal display panels 3R, 3G, and 3B by the liquid crystal display panel drivers 4R, 4G, and 4B are produced on the basis of images produced using a computer graphic technique, for example. That is, a polygon object and a plurality of pinholes are virtually arranged on a computer, to calculate data related to each of recording pixels in each of recording pixel areas, on a virtually provided recording surface, positioned on lines connecting each of points composing the polygon object and the pinholes. The data is data which will set the amount of light transmission at the pixel in the color of each of the liquid crystal display panels 3R, 3G, and 3B in a video display system. A voltage to be applied to the pixels in the color of each of the liquid crystal display panels 3R, 3G, and 3B positioned in the direction of light beams corresponding to the direction of vision in the video display system is set on the basis of the data.

The light beam synthesis system 5 is constructed by arranging a first dichroic mirror 5a and a second dichroic mirror 5b so as to cross each other. The first dichroic mirror 5a changes the optical path of video light beams (a group of light beams) from the red video generator 1R by 90° to introduce the video light beams whose optical path has been changed toward the viewer Z, and transmits video light beams (a group of light beams) from the green video generator 1G to introduce the transmitted video light beams toward the viewer Z. Further, the second dichroic mirror 5b changes the optical path of video light beams (a group of light beams) from the blue video generator 1B by 90° to introduce the video light beams whose optical path has been changed toward the viewer Z, and transmits video light beams (a group of light beams) from the green video generator 1G to introduce the transmitted video light beams toward the viewer Z. That is, the video light beams (the groups of light beams) from the video generators 1R, 1G, and 1B are synthesized, and are introduced into the viewer Z. In the present embodiment, the positions of the respective pinholes 22a in the video generators 1R, 1G, and 1B coincide with one another in a synthesized state, as shown in FIG. 2B.

In the above-mentioned configuration, out of the amounts of light transmission which will respectively represent certain portions of an object, a red light component is set by the red video generator 1R, a green light component is set by the green video generator 1G, and a blue light component is set by the blue video generator 1B. The groups of light beams in the respective colors are synthesized by the light beam synthesis system 5, and are introduced into the viewer Z. Consequently, more highly precise images can be reproduced, as compared with those in a case where only one color display in which pixels for red, pixels for green, and pixels for blue are provided on a single substrate is used. Since the dichroic mirrors 5a and 5b are used as the light beam synthesis system 5, bright stereoscopic video can be obtained by restraining the loss of light.

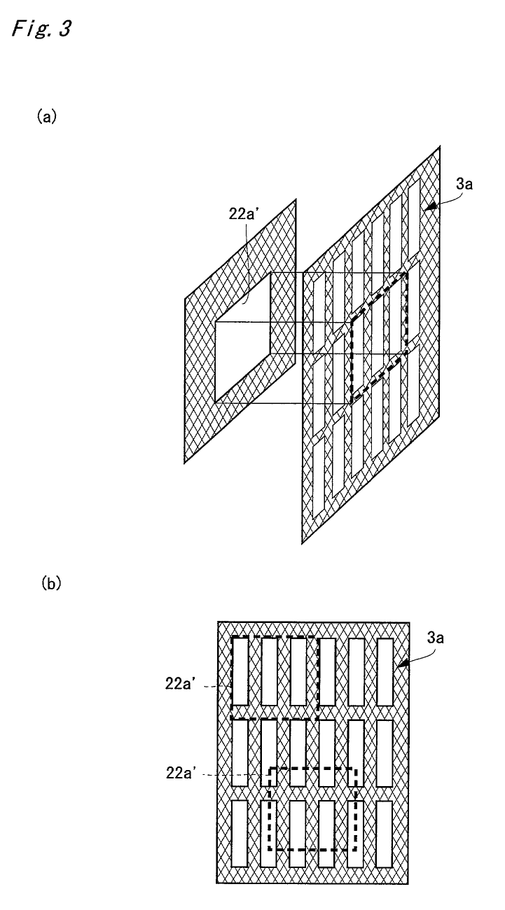

Although in the foregoing example, the pinhole 22a is made round, a square pinhole 22a′ may be employed, as shown in FIGS. 3A and 3B, because each of the liquid crystal display panels 3R, 3G, and 3B has a lattice-shaped black portion, and the width and the height thereof may be set to approximately integral multiples of a horizontal pitch and a vertical pitch of pixels. In the example shown in FIG. 3, one pixel area 3a is composed of 3 pixels by 6 pixels, and the width of the pinhole 22a′ is set to three times the horizontal pitch of the pixels, and the height thereof is set to one time the vertical pitch of the pixels.

In a stereoscopic video display device using a light beam reproduction system, when the head of a viewer is moved, the positions of visible pixels are shifted to or from a pinhole. If the pinhole 22a′ is used, as shown in FIG. 3B, however, the total area of the visible pixels is hardly changed even if the positions of visible pixels are shifted. That is, when the total area of the visible pixels is periodically changed by the movement of the head of the viewer, the intensity of light entering the eyes of the viewer is periodically changed so that the viewer sees moiré. However, the total area of the visible pixels is hardly changed even if the positions of visible pixels are shifted, thereby making it possible to reduce the moiré.

The video generators 1R, 1G, and 1B can be also so constructed that lights in colors are respectively emitted in the plate-shaped light sources 21, and the liquid crystal display panels respectively comprise no color transmission films. Further, the plate-shaped light sources 21 may be respectively replaced with light emitting means such as metal halide lamps, to separate red light beams, green light beams, and blue light beams using dichroic mirrors and introduce the lights in each of the colors to the video generator for the color using a mirror or the like.

Furthermore, it is also possible to employ a configuration eliminating the necessity of the pinhole array plate 22. For example, it is also possible to use three light emitting devices (for red light, for green light, and for blue light) each having single color light emitting diodes or the like arranged therein in an array, or use three CRTs (Cathode-Ray Tubes) for red light, for green light, and for blue light. Even when the light emitting diodes or the CRTs are used, a light emitting portion can be made square, and the width and the height thereof can be set to approximately integral multiples of a horizontal pitch and a vertical pitch of pixels. Further, the pinhole array plate can be also constructed using a liquid crystal shutter.

(Embodiment 2)

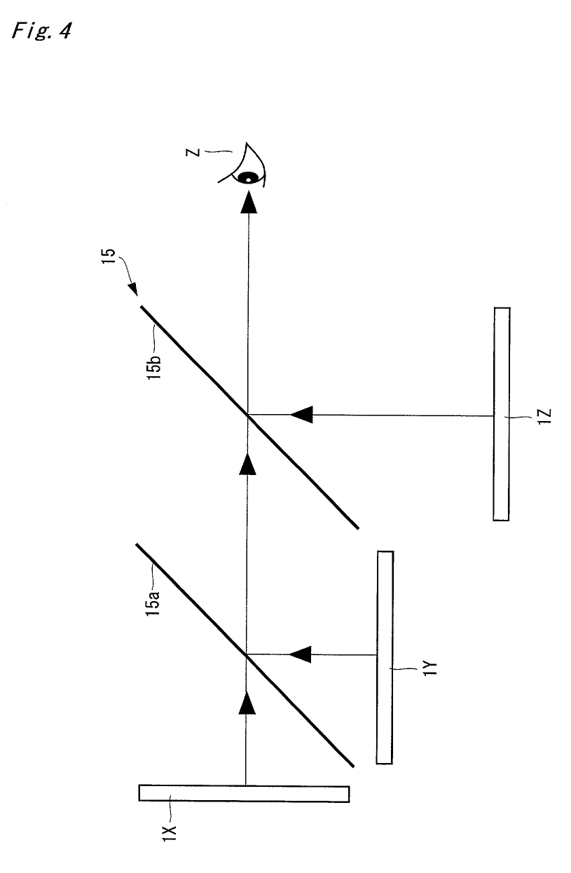

A stereoscopic video display device according to a second embodiment of the present invention will be described on the basis of FIGS. 4 to 7.

FIG. 4 is a side view showing the stereoscopic video display device according to the present embodiment. The stereoscopic video display device comprises three color video generators 1X, 1Y, and 1Z and a light beam synthesis system 15.

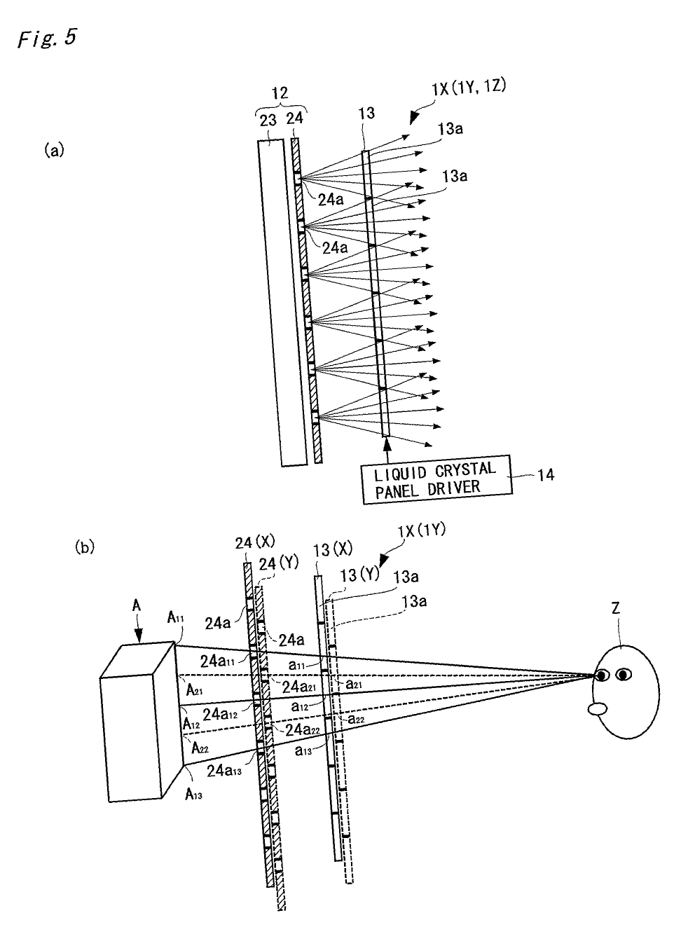

FIG. 5A illustrates the configuration of a color video generator 1X (1Y, 1Z). The color video generator 1X comprises a backlight 12, a transmission type color liquid crystal display panel 13 provided on the side of light emission of the backlight 12, and a liquid crystal panel driver 14 for driving the color liquid crystal display panel 13.

The backlight 12 comprises a plate-shaped light source 23 for emitting white light and a pinhole array plate 24. The pinhole array plate 24 has a plurality of round pinholes 24a formed therein with predetermined spacing. A group of light beams is given to the color liquid crystal display panel 13 from each of the pinholes

The color liquid crystal display panel 13 is constructed by providing on a single substrate pixels for red, pixels for green, and pixels for blue. The liquid crystal display panel driver 14 feeds a pixel driving signal to the color liquid crystal display panel 13, to form pixel areas 13a, each composed of a plurality of p pixels, respectively corresponding to the pinholes 24a. The pixel area 13a is composed of 6 to 20 pixels in width and 3 to 20 pixels in length, for example. The pixels composing the pixel area 13a respectively control the amounts of light transmission of light beams in each direction from the corresponding pinhole 24a. Consequently, the intensity of the light beam in each of the directions is reproduced.

The driving signals respectively fed to the color liquid crystal display panels 13 by the liquid crystal display panel drivers 14 are produced on the basis of images produced using a computer graphic technique, for example. That is, a polygon object and a plurality of pinholes are virtually arranged on a computer, to calculate data related to each of recording pixels in each of recording pixel areas, on a virtually provided recording surface, positioned on lines connecting each of points composing the polygon object and the pinholes. The data is data which will set the amount of light transmission at the pixels in the color of each of the color liquid crystal display panels 13 in a video display system. A voltage to be applied to the pixels in the color of each of the color liquid crystal display panels 13 positioned in the direction of light beams corresponding to the direction of vision in the video display system is set on the basis of the data.

Images to be displayed on the respective color liquid crystal display panels 13 in the three color video generators 1X, 1Y, and 1Z differ from one another. As described later, the color video generators are set such that the positions of the respective pinholes are shifted in a video synthesized state. Accordingly, the respective pixels in the pixel areas 13a in the color liquid crystal display panels 13 control the amounts of light transmission of the light beams in each of the directions from the corresponding pinholes 24a whose positions are shifted from one another.

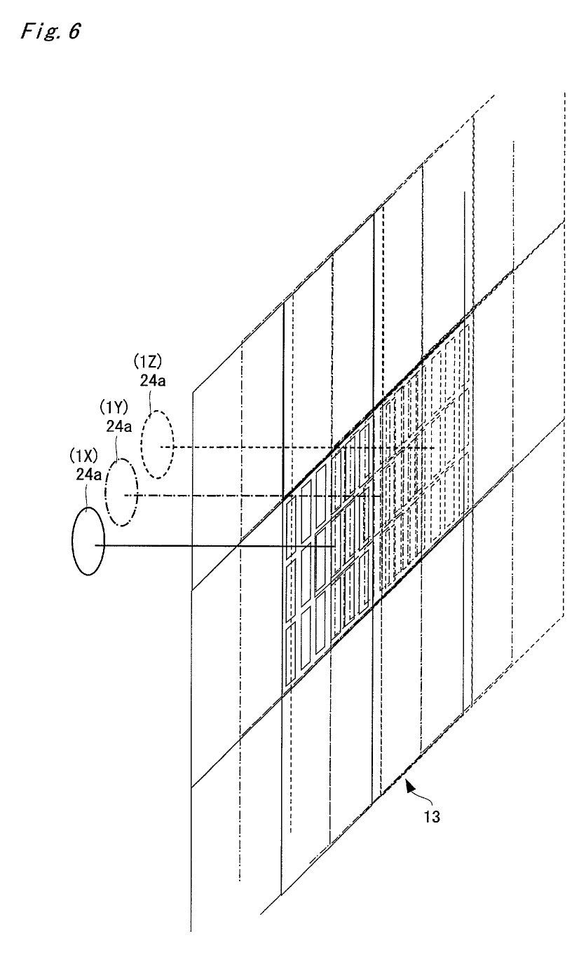

The light beam synthesis system 15 comprises a first half mirror 15a and a second half mirror 15b. The first half mirror 15a transmits video light beams (a group of light beams) from the color video generator 1X to introduce the transmitted video light beams toward a viewer Z, and changes the optical path of video light beams (a group of light beams) from the color video generator 1Y by 90° to introduce the video light beams whose optical path has been changed toward the viewer Z. Further, the second half mirror 15b transmits video light beams (a groups of light beams) which have passed through the first half mirror 15a from each of the color video generators 1X and 1Y to introduce the transmitted video light beams toward the viewer Z. and changes the optical path of video light beams (a group of light beams) from the color video generator 1Z by 90° to introduce the video light beams whose optical path has been changed toward the viewer Z. That is, the video light beams (the groups of light beams) from the color video generators 1X, 1Y, and 1Z are synthesized, and are introduced into the viewer Z. The positions of the respective pinholes 24a in the color video generators 1X, 1Y, and 1Z are shifted in the horizontal direction such that the pinholes 24a are not overlapped with one another in the above-mentioned synthesized state, as shown in FIG. 6.

The stereoscopic video display device comprises the plurality of color video generators, and is so constructed as to synthesize respective color video therefrom, and is so set that the respective pinholes 24a are not overlapped with one another in the synthesized state, thereby improving substantial resolution (increasing the number of light beams for reproducing an object) to obtain images of good quality. Although the specific explanation is made on the basis of FIG. 5B, only the two color video generators 1X and 1Y are drawn in FIG. 5B in order to prevent the drawing from being complicated.

In the color video generator 1X, an amount of light transmission which represents a portion A11 of an object A can be set at a pixel all in a pixel area which will receive a predetermined light beam from a pinhole 24a11, an amount of light transmission which represents a portion A12 of the object A can be set at a pixel a12 in a pixel area which will receive a predetermined light beam from a pinhole 24a12, and an amount of light transmission which represents a portion A13 of the object A can be set at a pixel a13 in a pixel area which will receive a predetermined light beam from a pinhole 24a13, as indicated by solid lines.

On the other hand, in the color video generator 1Y, an amount of light transmission which represents a portion A21 of the object A can be set at a pixel a21 in a pixel area which will receive a predetermined light beam from a pinhole 24a21, and an amount of light transmission which represents a portion A22 of the object A can be set at a pixel a22 in a pixel area which will receive a predetermined light beam from a pinhole 24a22, as indicated by dotted lines. That is, a larger number of light beams to be reproduced can be obtained, as compared with those in a case where the number of color video generators is only one.

It is desirable that in the three color video generators 1X, 1Y, and 1Z, the images to be displayed on the respective color liquid crystal display panels 13 differ from one another in correspondence with the amount of shift among the pinholes 24a. However, the amount of shift among the pinholes 24a in the video synthesized state is small. Even if the displayed images are entirely the same (of course, processing for turning each of the displayed images upside down, for example, is performed in consideration of synthesis), an effect is obtained for the time being. In this case, the number of images to be produced by the computer graphics may be one, thereby making it possible to reduce the burden on image production. Further, although each of the pinholes 24a is shifted in the lateral direction, it may be shifted in a so-called triangle arrangement manner.

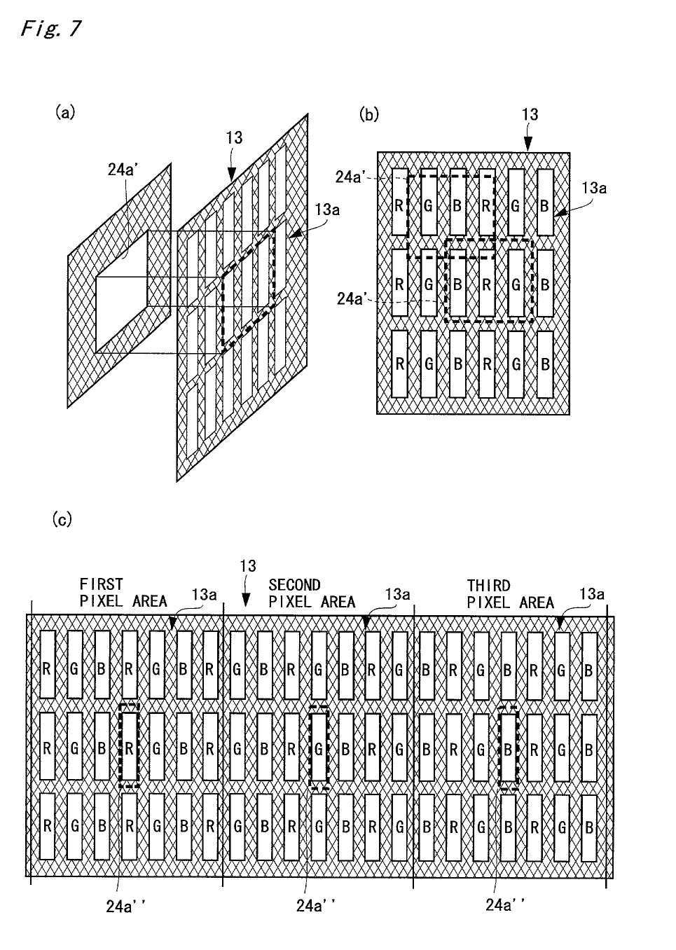

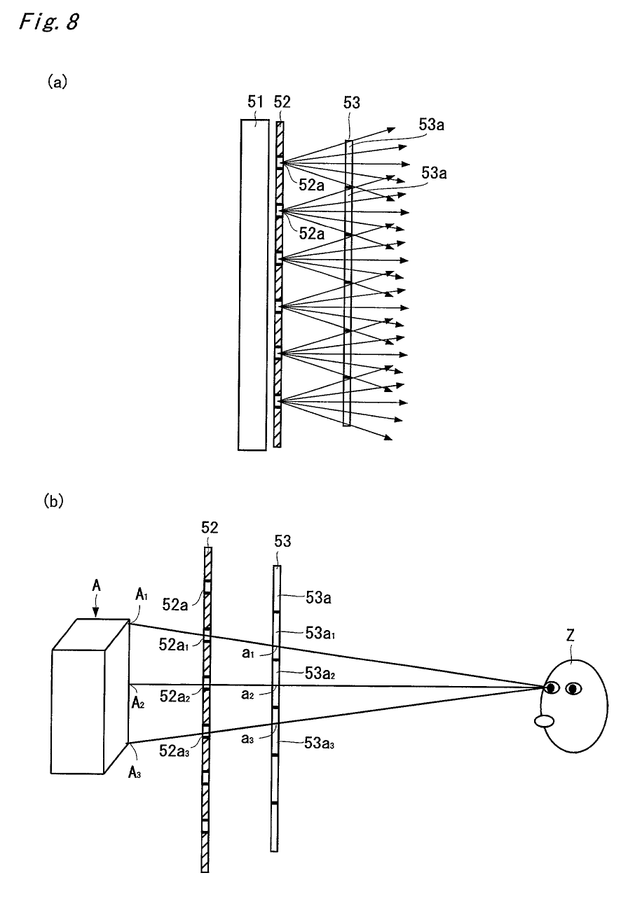

Meanwhile, the pinhole array plate may have a pinhole 24a′ of a size including all pixels in the three primary colors in the color liquid crystal display panel 13 at an equal ratio, as shown in FIGS. 7A and 7B. In an example shown in FIGS. 7A and 7B, one pixel area 13a is composed of 3 pixels by 6 pixels, and the pinhole 24a′ is a size including one pixel for R (red), one pixel for G (green), and one pixel for B (blue). In a stereoscopic video display device using a light beam reproduction system, when the head of a viewer is moved, the positions of visible pixels are shifted to or from a pinhole. If the pinhole 24a′ is used, as shown in FIG. 7B, however, the ratio of red, green, and blue of the visible pixels is hardly changed even if the positions of visible pixels are shifted from one another, thereby making it possible a~ to perform good white display.

Particularly in a case where lines each connecting the center of a pixel area and the center of a pinhole are made to cross each other at a position corresponding to the standard distance between a color video display panel and a viewer so that light beams are efficiently gathered in the viewer, the configuration as shown in FIGS. 7A and 7B or a configuration as shown in FIG. 7C, described later, may be used. Further, it is desirable that not a round pinhole but a square pinhole 24a′, as illustrated, is used. The size of the pinhole is not limited to a size including one pixel for R, one pixel for G, and one pixel for B. For example, it may be a size including pixels for R, pixels for G, and pixels for B at the same ratio.

The number of pixels in at least one of the lateral direction and the longitudinal direction in the pixel area 13a may be a number other than multiples of three, and the size of the pinhole may be set to a size including pixels in only one or two of the three primary colors or a size including the pixels in the one or two colors extra in addition to the pixels in the three primary colors. In an example shown in FIG. 7C, the number of pixels in width in a pixel area 13a is set to seven, and a pinhole 24a″ of a size including pixels in only one of the three primary colors in a color liquid crystal display panel 13 is employed. In such a configuration, white display is ensured at the three pixels (middle pixels, for example) which correspond to one another in adjacent three pixel areas. Also in such a configuration, the ratio of red, green, and blue of the visible pixels is hardly changed, thereby making it possible to ensure good white display.

Although in the above-mentioned example, description was made of a configuration corresponding to a stereoscopic video display device using a light beam reproduction system in which a video display panel is arranged ahead of a dot light source, a stereoscopic video display device using a light beam reproduction system in which a pinhole array plate or the like is arranged ahead of a display can be taken as a stereoscopic video display device having a synthesis system.

Specifically, a stereoscopic video display device may comprise a display for red, a display for Miss green, and a display for blue, dot-shaped light transmission area forming panels, each having dot-shaped light transmitters on which video light from the corresponding display is incident in a plane shape with predetermined spacing and giving a group of light beams corresponding to light scattered from an object , which are respectively arranged on the side of video light emission of the displays, a red display driver, a green display driver, and a blue display driver which are provided as a display driver for setting an image to be displayed in pixel areas, of the video display panel, corresponding to the light transmitters, and a light beam synthesis system for synthesizing the group of light beams from the display for red, the group of light beams from the display for green, and the group of light beams from the display for blue and emitting the synthesized groups of light beams. The form shown in FIG. 1 can be utilized for such a configuration. In this case, the positions of the corresponding light transmitters in red, green, and blue may be so set as to be overlapped with one another in a video synthesized state.

A stereoscopic video display device may comprise a plurality of color displays each displaying an image, dot-shaped light transmission area forming panels each having light transmitters on which video light from the corresponding color display is incident in a plane shape with predetermined spacing and provided on the side of video light emission of the color display in order to give a group of light beams corresponding to light scattered from an object, display drivers each setting an image to be displayed in pixel areas, of the color display, corresponding to the light transmitters, and a light beam synthesis system for synthesizing the groups of light beams which have passed through the respective color displays and emitting the synthesized groups of light beams. The positions of the corresponding light transmitters of the dot-shaped light transmission area forming panels in a synthesized state by the light beam synthesis system may be shifted from one another. In this case, the color images to be respectively displayed on the color displays may be the same, or may differ in correspondence with the shifts among the positions of the light transmitters. The form shown in FIG. 4 can be utilized for such a configuration.

In a dot-shaped light transmission member having dot-shaped light transmitters arranged therein in a plane shape with predetermined spacing and giving a group of light beams corresponding to light scattered from an object to light beams respectively emitted from pixels composing a display having a lattice-shaped black portion by the dot-shaped light transmitters, the dot-shaped light transmitter may form a square shape, and the width and the height thereof may be set to approximately integral multiples of a horizontal pitch and a vertical pitch of the pixels. Such a configuration corresponds to the configuration shown in FIG. 3.

In a dot-shaped light transmission member having dot-shaped light transmitters arranged therein in a plane shape with predetermined spacing and giving a group of light beams corresponding to light scattered from an object to light beams respectively emitted from pixels composing each of pixel areas of a color display by the dot-shaped light transmitters, the size of the dot-shaped light transmitter may be set to a size including all the pixels in the three primary colors in the color display at an equal ratio. Such a configuration corresponds to the configuration shown in FIGS. 7A and 7B.

In a dot-shaped light transmission member having dot-shaped light transmitters arranged therein in a plane shape with predetermined spacing and giving a group of light beams corresponding to light scattered from an object to light beams respectively emitted from pixels composing each of pixel areas of a color display by the dot-shaped light transmitters, the number of pixels in at least one of the lateral direction and the longitudinal direction in the pixel area may be set to a number other than multiples of three, and the size of the dot-shaped light transmitter may be set to a size including the pixels in only one or two of the three primary colors in the color display or a size including the pixels in the one or two colors extra in addition to the pixels in the three primary colors. Such a configuration corresponds to the configuration shown in FIG. 7C.

In such a configuration that a pinhole array plate or the like is arranged ahead of a display, it is possible to use as the display a self light emission type video display panel (an LED (Light Emitting Diode), an organic EL (Electroluminescent) display, a plasma display, etc.), a CRT, etc. in addition to a transmission type liquid crystal display panel (requiring a backlight).

As described in the foregoing, according to the present invention, the number of light beams to be reproduced is substantially increased, thereby making it possible to produce stereoscopic images of good quality. Further, the effects of reducing moiré and keeping white display good, for example, are also produced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A stereoscopic video display device comprising:
a backlight for red, a backlight for green, and a backlight for blue which are provided as a backlight constructed by arranging dot-shaped light emitters each giving a group of light beams corresponding to light scattered from an object in a plane shape with predetermined spacing;
a light bulb for red, a light bulb for green, and a light bulb for blue which are respectively arranged on the side of light emission of said backlights;
a red light bulb driver, a green light bulb driver, and a blue light bulb driver which are provided as a light bulb driver for setting an image to be displayed in pixel areas, of said light bulb, corresponding to the light emitters of said backlight; and
a light beam synthesis system for synthesizing the group of light beams which has passed through said light bulb for red, the group of light beams which has passed through said light bulb for green, and the group of light beams which has passed through said light bulb for blue and emitting the synthesized groups of light beams.

2. A stereoscopic video display device comprising:
a display for red, a display for green, and a display for blue;
dot-shaped light transmission area forming panels, each having dot-shaped light transmitters on which video light from the corresponding display is incident in a plane shape with predetermined spacing and giving a group of light beams corresponding to light scattered from an object, which are respectively arranged on the side of video light emission of the displays;
a red display driver, a green display driver, and a blue display driver which are provided as a display driver for setting an image to be displayed in pixel areas, of said display, corresponding to the light transmitters; and
a light beam synthesis system for synthesizing the group of light beams from said display for red, the group of light beams from said display for green and the group of light beams from said display for blue and emitting the synthesized groups of light beams.

3. The stereoscopic video display device according to claim 1, wherein
the positions of the corresponding light emitters or the corresponding light transmitters in red, green, and blue are overlapped with one another in a video synthesized state.

4. The stereoscopic video display device according to claim 2, wherein
the positions of the corresponding light emitters or the corresponding light transmitters in red, green, and blue are overlapped with one another in a video synthesized state.

5. The stereoscopic video display device according to claim 1, wherein
said light beam synthesis system is composed of a dichroic mirror.

6. The stereoscopic video display device according to claim 2, wherein
said light beam synthesis system is composed of a dichroic mirror.

7. The stereoscopic video display device according to claim 3, wherein
said light beam synthesis system is composed of a dichroic mirror.

8. The stereoscopic video display device according to claim 4, wherein
said light beam synthesis system is composed of a dichroic mirror.

9. A stereoscopic video display device comprising
a plurality of white backlights each constructed by arranging dot-shaped light emitters each giving a group of light beams corresponding to light scattered from an object in a plane shape with predetermined spacing;
color light bulbs which are respectively arranged on the side of light emission of the white backlights;
light bulb drivers each setting a color display image to be displayed in pixel areas, of the color light bulb, corresponding to the light emitters of the white backlight; and
a light beam synthesis system for synthesizing the groups of light beams which have respectively passed through the color light bulbs and emitting the synthesized groups of light beams,
the positions of the corresponding light emitters of the white backlights in a synthesized state by said light beam synthesis system being shifted from one another.

10. A stereoscopic video display device comprising:
a plurality of color displays each displaying an image;
dot-shaped light transmission area forming panels each having dot-shaped light transmitters on which video light from the corresponding color display is incident in a plane shape with predetermined spacing and provided on the side of video light emission of the color display in order to give a group of light beams corresponding to light scattered from an object;
display drivers each setting an image to be displayed in pixel areas, of said color display, corresponding to the light transmitters; and
a light beam synthesis system for synthesizing the groups of light beams from the respective color displays and emitting the synthesized groups of light beams,
the positions of the corresponding light transmitters of the dot-shaped light transmission area forming panels in a synthesized state by said light beam synthesis system being shifted from one another.

11. The stereoscopic video display device according to claim 9, wherein
the color display images respectively displayed in the color light bulbs are the same.

12. The stereoscopic video display device according to claim 10, wherein
the color display images respectively displayed in the color displays are the same.

13. The stereoscopic video display device according to claim 9, wherein
the color display images respectively displayed in the color light bulbs differ in correspondence with the shifts among the positions of said light emitters.

14. The stereoscopic video display device according to claim 10, wherein
the color display images respectively displayed in the color displays differ in correspondence with the shifts among the positions of said light transmitters.

15. The stereoscopic video display device according to claim 9, wherein
said light beam synthesis system is composed of a half mirror.

16. The stereoscopic video display device according to claim 10, wherein
said light beam synthesis system is composed of a half mirror.

17. The stereoscopic video display device according to claim 11, wherein
said light beam synthesis system is composed of a half mirror.

18. The stereoscopic video display device according to claim 12, wherein
said light beam synthesis system is composed of a half mirror.

19. The stereoscopic video display device according to claim 13, wherein
said light beam synthesis system is composed of a half mirror.

20. The stereoscopic video display device according to claim 14, wherein
said light beam synthesis system is composed of a half mirror.

21. In a stereoscopic video display device comprising a light bulb having a lattice-shaped black portion,
a stereoscopic video display device comprising:
a dot-shaped light emission member having dot-shaped light emitters arranged therein in a plane shape with predetermined spacing and giving a group of light beams corresponding to light scattered from an object to pixels composing the light bulb having the lattice-shaped black portion by said dot-shaped light emitters,
said dot-shaped light emitter forming a square shape, and the width and the height thereof being set to approximately integral multiples of a horizontal pitch and a vertical pitch of said pixels.

22. In a stereoscopic video display device comprising a display having a lattice-shaped black portion,
a stereoscopic video display device comprising:
a dot-shaped light transmission member having dot-shaped light transmitters arranged therein in a plane shape with predetermined spacing and giving a group of light beams corresponding to light scattered from an object to light beams respectively emitted from pixels composing the display having the lattice-shaped black portion by said dot-shaped light transmitters,
said dot-shaped light transmitter forming a square shape, and the width and the height thereof being set to approximately integral multiples of a horizontal pitch and a vertical pitch of said pixels.

23. In a stereoscopic video display device comprising a color light bulb,
a stereoscopic video display device comprising:
a dot-shaped light emission member having dot-shaped light emitters arranged therein in a plane shape with predetermined spacing and giving a group of light beams corresponding to light scattered from an object to pixels composing each of pixel areas of the color light bulb by said dot-shaped light emitters,
the size of said dot-shaped light emitter being set to a size including all the pixels in the three primary colors in said color light bulb at an equal ratio.

24. In a stereoscopic video display device comprising a color display,
a stereoscopic video display device comprising:
a dot-shaped light transmission member having dot-shaped light transmitters arranged therein in a plane shape with predetermined spacing and giving a group of light beams corresponding to light scattered from an object to light beams respectively emitted from pixels composing each of pixel areas of the color display by said dot-shaped light transmitters,
the size of said dot-shaped light transmitter being set to a size including all the pixels in the three primary colors in said color display at an equal ratio.

25. In a stereoscopic video display device comprising a color light bulb,
a stereoscopic video display device comprising:
a dot-shaped light emission member having dot-shaped light emitters arranged therein in a plane shape with predetermined spacing and giving a group of light beams corresponding to light scattered from an object to pixels composing each of pixel areas of the color light bulb by said dot-shaped light emitters,
the number of pixels in at least one of the lateral direction and the longitudinal direction in said pixel area being a number other than multiples of three, and
the size of said dot-shaped light emitter being set to a size including the pixels in one or two of the three primary colors in said color light bulb or a size including the pixels in the one or two colors extra in addition to the pixels in the three primary colors.

26. In a stereoscopic video display device comprising a color display,
a stereoscopic video display device comprising:
a dot-shaped light transmission member having dot-shaped light transmitters arranged therein in a plane shape with predetermined spacing and giving a group of light beams corresponding to light scattered from an object to light beams respectively emitted from pixels composing each of pixel areas of the color display by said dot-shaped light transmitters,
the number of pixels in at least one of the lateral direction and the longitudinal direction in said pixel area being a number other than multiples of three, and
the size of said dot-shaped light transmitter being set to a size including the pixels in one or two of the three primary colors in said color display or a size including the pixels in the one or two colors extra in addition to the pixels in the three primary colors.

27. In a dot-shaped light emission member having dot-shaped light emitters arranged therein in a plane shape with predetermined spacing and giving a group of light beams corresponding to light scattered from an object to pixels composing a light bulb having a lattice-shaped black portion by said dot-shaped light emitters,
a dot-shaped light emission member wherein
said dot-shaped light emitter forms a square shape, and the width and the height thereof are set to approximately integral multiples of a horizontal pitch and a vertical pitch of said pixels.

28. In a dot-shaped light transmission member having dot-shaped light transmitters arranged therein in a plane shape with predetermined spacing and giving a group of light beams corresponding to light scattered from an object to light beams respectively emitted from pixels composing a display having a lattice-shaped black portion by said dot-shaped light transmitters,
a dot-shaped light transmission member wherein
said dot-shaped light transmitter forms a square shape, and the width and the height thereof are set to approximately integral multiples of a horizontal pitch and a vertical pitch of said pixels.

29. In a dot-shaped light emission member having dot-shaped light emitters arranged therein in a plane shape with predetermined spacing and giving a group of light beams corresponding to light scattered from an object to pixels composing each of pixel areas of a color light bulb by said dot-shaped light emitters,
a dot-shaped light emission member wherein
the size of said dot-shaped light emitter is set to a size including all the pixels in the three primary colors in said color light bulb at an equal ratio.

30. In a dot-shaped light transmission member having dot-shaped light transmitters arranged therein in a plane shape with predetermined spacing and giving a group of light beams corresponding to light scattered from an object to light beams respectively emitted from pixels composing each of pixel areas of a color display by said dot-shaped light transmitters,
a dot-shaped light transmission member wherein
the size of said dot-shaped light transmitter is set to a size including all the pixels in the three primary colors in said color display at an equal ratio.

31. In a dot-shaped light emission member having dot-shaped light emitters arranged therein in a plane shape with predetermined spacing and giving a group of light beams corresponding to light scattered from an object to pixels composing each of pixel areas of a color light bulb by said dot-shaped light emitters,
a dot-shaped light emission member wherein
the number of pixels in at least one of the lateral direction and the longitudinal direction in said pixel area is a number other than multiples of three, and
the size of said dot-shaped light emitter is set to a size including the pixels in one or two of the three primary colors in said color light bulb or a size including the pixels in the one or two colors extra in addition to the pixels in the three primary colors.

32. In a dot-shaped light transmission member having dot-shaped light transmitters arranged therein in a plane shape with predetermined spacing and giving a group of light beams corresponding to light scattered from an object to light beams respectively emitted from pixels composing each of pixel areas of a color display by said dot-shaped light transmitters,
a dot-shaped light transmission member wherein
the number of pixels in at least one of the lateral direction and the longitudinal direction in said pixel area is a number other than multiples of three, and
the size of said dot-shaped light transmitter is set to a size including the pixels in one or two of the three primary colors in said color display or a size including the pixels in the one or two colors extra in addition to the pixels in the three primary colors.
